(19) United States
(12) Patent Application Publication
(10) Pub. No.: US 2020/0065098 A1
(43) Pub. Date: Feb. 27, 2020

(54) PROVIDING EFFICIENT HANDLING OF BRANCH DIVERGENCE IN VECTORIZABLE LOOPS BY VECTOR-PROCESSOR-BASED DEVICES

(71) Applicant: QUALCOMM Incorporated, San Diego, CA (US)

(72) Inventors: Hadi Parandeh Afshar, San Diego, CA (US); Eric Rotenberg, Raleigh, NC (US); Gregory Michael Wright, Chapel Hill, NC (US)

(21) Appl. No.: 16/107,136

(22) Filed: Aug. 21, 2018

(51) Int. Cl. G06F 9/30; G06F 9/48; G06F 9/52; G06F 1/06

(52) U.S. Cl. CPC G06F 9/30065; G06F 9/4887; G06F 9/52; G06F 9/30036; G06F 9/30018; G06F 9/3013; G06F 1/06

(57) ABSTRACT

Providing efficient handling of branch divergence in vectorizable loops by vector-processor-based devices is disclosed. In some aspects, a vector-processor-based device provides a plurality of processing elements (PEs) coupled to a scheduler circuit comprising a clock cycle threshold and a mask register comprising a plurality of bits corresponding to a plurality of loop iterations of a vectorizable loop to be executed. The scheduler circuit initiates a first execution interval, during which loop iterations of the vectorizable loop are assigned to PEs for parallel execution. If a loop iteration's execution time exceeds the clock cycle threshold, the scheduler circuit sets a mask register bit corresponding to the loop iteration indicating that the loop iteration is incomplete, and defers its execution. After the first execution interval is complete, the scheduler circuit initiates a second execution interval, during which incomplete loop iterations indicated by the mask register are executed in parallel by the PEs.

### BACKGROUND

### I. Field of the Disclosure

The technology of the disclosure relates generally to vector-processor-based devices, and, in particular, to efficient processing of vectorizable loops by vector-processor-based devices.

### II. Background

Vector-processor-based devices are computing devices that employ vector processors capable of operating on one-dimensional arrays of data (“vectors”) using a single program instruction. Vector-processor-based devices may be particularly useful for processing loops that involve a high degree of data level parallelism. Conventional vector processors may process such a loop using multiple identical “vector lanes” that are each configured to execute a same instruction in lockstep fashion across all of the vector lanes. Each iteration of the loop is mapped to a different vector lane, and all vector lanes are used to execute different loop iterations in parallel. A loop that can be processed in this manner may be referred to as a “vectorizable loop.”

However, a phenomenon known as “branch divergence” may reduce the efficiency of vectorizable loop processing by the vector-processor-based device. Branch divergence occurs during execution of a vectorizable loop when loop iterations of the vectorizable loop do not all execute the same sequence of instructions. For example, the vectorizable loop may include a branch instruction that results in one control flow in some loop iterations, but a different control flow in other loop iterations. As a result, parallel execution of multiple loop iterations of the vectorizable loop may not be possible because the same instructions can no longer be executed in lockstep across all vector lanes of the vector-processor-based device.

One approach to addressing the issue of branch divergence involves executing every potential branch path sequentially across all vector lanes, and then using predicate masks to appropriately merge the execution results. This approach, though, may incur significant performance overhead, as each potential instance of branch divergence will result in a delay equaling the sum of the delays across all of the potential branch paths. Moreover, this approach is also energy inefficient, as each vector lane must execute every mutually exclusive branch path.

Another approach, used in conventional vector thread (VT) architectures, substitutes the vector lanes with multiple processing elements (PEs) that are configured to independently execute a sequence of instructions, and then synchronize execution results at a pre-defined boundary (e.g., upon performing a memory access operation). This VT architecture approach may reduce the performance overhead compared to sequential execution of every potential branch path, as the delay incurred under this approach equals the greater delay of the potential branch paths. However, even under the VT architecture approach, some scenarios may still prove problematic. For example, if the vectorizable loop contains multiple branches and a small number of loop iterations take the longer of each potential branch path, those loop iterations may create bottlenecks that negatively affect the execution time of the entire vectorizable loop. These bottleneck loop iterations may prove particularly problematic if the total number of loop iterations is significantly higher than the number of PEs (such that multiple PE execution iterations are required to process the entire vectorizable loop), and the bottleneck loop iterations are spaced out such that there is one bottleneck iteration within each PE execution iteration.

### SUMMARY OF THE DISCLOSURE

Aspects disclosed in the detailed description include providing efficient handling of branch divergence in vectorizable loops by vector-processor-based devices. In this regard, a vector-processor-based device provides a plurality of processing elements (PEs) that are coupled to a scheduler circuit, and that are each configured to execute a loop iteration of a plurality of loop iterations of a vectorizable loop concurrently with other PEs of the plurality of PEs. The scheduler circuit maintains a clock cycle threshold that specifies a maximum number of clock cycles that each loop iteration of a vectorizable loop will be allowed to execute. The scheduler circuit also provides a mask register comprising a plurality of bits that correspond to a plurality of loop iterations of the vectorizable loop to be executed. To execute the vectorizable loop, the scheduler circuit initiates a first execution interval, during which loop iterations of the vectorizable loop are assigned to PEs for parallel execution. During the first execution interval, the scheduler circuit monitors the execution time (measured in clock cycles) of each loop iteration by the corresponding PE. If the execution time exceeds the clock cycle threshold, the scheduler circuit sets a bit of the mask register corresponding to the loop iteration to indicate that the loop iteration is an incomplete loop iteration, and then defers execution of the incomplete loop iteration. After the first execution interval is complete, the scheduler circuit then initiates a second execution interval, during which each deferred incomplete loop iteration indicated by the mask register is executed in parallel by the PEs. In this manner, any bottleneck loop iterations are filtered by the scheduler circuit and executed in parallel, thereby incurring the worst-case delay only during the second execution interval. This results in better overall performance and reduced power consumption, and enables updates to a vector register file by the PEs to be performed using concurrent synchronized accesses rather than sparse accesses.

In another aspect, a vector-processor-based device for handling branch divergence in vectorizable loops is provided. The vector-processor-based device comprises a plurality of PEs, each of which is configured to execute a loop iteration of a plurality of loop iterations of a vectorizable loop concurrently with other PEs of the plurality of PEs. The vector-processor-based device further comprises a scheduler circuit comprising a mask register and a clock cycle threshold. The scheduler circuit is configured to initiate a first execution interval to execute in parallel the plurality of loop iterations of the vectorizable loop using the plurality of PEs. The scheduler circuit is further configured to, during the first execution interval, determine, for each PE of the plurality of PEs, whether execution of each loop iteration of the plurality of loop iterations of the vectorizable loop by the PE exceeds the clock cycle threshold. The scheduler circuit is also configured to, responsive to determining that the execution of the loop iteration exceeds the clock cycle threshold, set a bit of the mask register corresponding to the loop iteration to indicate that the loop iteration is an incomplete loop iteration, and defer execution of the incomplete loop iteration. The scheduler circuit is additionally configured to, subsequent to completion of the first execution interval, initiate a second execution interval to execute in parallel each incomplete loop iteration of the plurality of loop iterations of the vectorizable loop using one or more PEs of the plurality of PEs, based on the mask register.

In another aspect, a vector-processor-based device for handling branch divergence in vectorizable loops is provided. The vector-processor-based device comprises a means for initiating a first execution interval to execute in parallel a plurality of loop iterations of a vectorizable loop using a plurality of PEs of the vector-processor-based device, wherein each PE is configured to execute a loop iteration of the plurality of loop iterations concurrently with other PEs of the plurality of PEs. The vector-processor-based device further comprises a means for determining, for each PE of the plurality of PEs during the first execution interval, whether execution of each loop iteration of the plurality of loop iterations of the vectorizable loop by the PE exceeds a clock cycle threshold. The vector-processor-based device also comprises a means for setting a bit of a mask register corresponding to the loop iteration to indicate that the loop iteration is an incomplete loop iteration, responsive to determining that the execution of the loop iteration exceeds the clock cycle threshold. The vector-processor-based device additionally comprises a means for deferring execution of the incomplete loop iteration, further responsive to determining that the execution of the loop iteration exceeds the clock cycle threshold. The vector-processor-based device further comprises a means for initiating a second execution interval to execute in parallel each incomplete loop iteration of the plurality of loop iterations of the vectorizable loop using one or more PEs of the plurality of PEs subsequent to completion of the first execution interval, based on the mask register.

In another aspect, a method for handling branch divergence in vectorizable loops is provided. The method comprises initiating, by a scheduler circuit of a vector-processor-based device, a first execution interval to execute in parallel a plurality of loop iterations of a vectorizable loop using a plurality of PEs of the vector-processor-based device, wherein each PE is configured to execute a loop iteration of the plurality of loop iterations concurrently with other PEs of the plurality of PEs. The method further comprises, during the first execution interval, determining, for each PE of the plurality of PEs, whether execution of each loop iteration of the plurality of loop iterations of the vectorizable loop by the PE exceeds a clock cycle threshold of the scheduler circuit. The method also comprises, responsive to determining that the execution of the loop iteration exceeds the clock cycle threshold, setting a bit of a mask register of the scheduler circuit corresponding to the loop iteration to indicate that the loop iteration is an incomplete loop iteration, and deferring execution of the incomplete loop iteration. The method additionally comprises, subsequent to completion of the first execution interval, initiating a second execution interval to execute in parallel each incomplete loop iteration of the plurality of loop iterations of the vectorizable loop using one or more PEs of the plurality of PEs, based on the mask register.

In another aspect, a non-transitory computer-readable medium is provided, having stored thereon computer-executable instructions for causing a vector processor of a vector-processor-based device to initiate a first execution interval to execute in parallel a plurality of loop iterations of a vectorizable loop using a plurality of PEs of the vector-processor-based device, wherein each PE is configured to execute a loop iteration of the plurality of loop iterations concurrently with other PEs of the plurality of PEs. The computer-executable instructions further cause the vector processor to, during the first execution interval, determine, for each PE of the plurality of PEs, whether execution of each loop iteration of the plurality of loop iterations of the vectorizable loop by the PE exceeds a clock cycle threshold. The computer-executable instructions also cause the vector processor to, responsive to determining that the execution of the loop iteration exceeds the clock cycle threshold, set a bit of a mask register corresponding to the loop iteration to indicate that the loop iteration is an incomplete loop iteration, and defer execution of the incomplete loop iteration. The computer-executable instructions additionally cause the vector processor to, subsequent to completion of the first execution interval, initiate a second execution interval to execute in parallel each incomplete loop iteration of the plurality of loop iterations of the vectorizable loop using one or more PEs of the plurality of PEs, based on the mask register.

### BRIEF DESCRIPTION OF THE FIGURES

FIG. 1 is a block diagram illustrating a vector-processor-based device including a plurality of processing elements (PEs) and a scheduler circuit for handling branch divergence in vectorizable loops;

FIG. 2 is a block diagram illustrating processing of loop iterations of a vectorizable loop, including instances of branch divergence, by conventional vector-processor-based devices;

FIG. 3 is a block diagram illustrating handling of branch divergence during processing of loop iterations of a vectorizable loop by the plurality of PEs and the scheduler circuit of FIG. 1;

FIGS. 4A and 4B are flowcharts illustrating exemplary operations performed by the plurality of PEs and the scheduler circuit of FIG. 1 for providing efficient handling of branch divergence in vectorizable loops; and

FIG. 5 is a block diagram of an exemplary processor-based system that can include the plurality of PEs and the scheduler circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

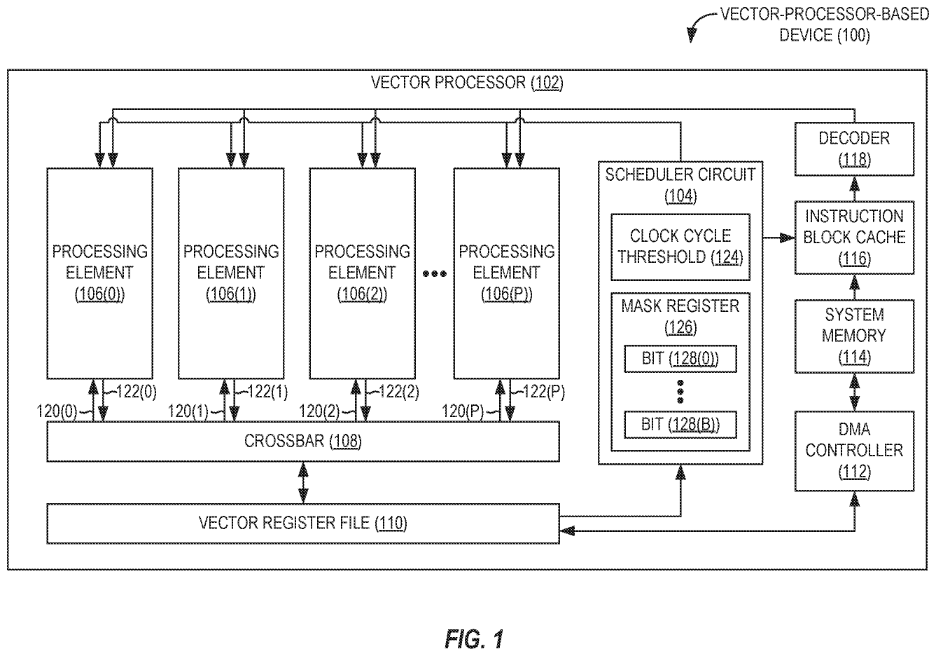

Aspects disclosed in the detailed description include providing efficient handling of branch divergence in vectorizable loops by vector-processor-based devices. In this regard, FIG. 1 illustrates a vector-processor-based device 100 that implements a block-based dataflow instruction set architecture (ISA), and that provides a vector processor 102 comprising a scheduler circuit 104. The vector processor 102 includes a plurality of processing elements (PEs) 106(0)-106(P), each of which may comprise a processor having one or more processor cores, or an individual processor core comprising a logical execution unit and associated caches and functional units, as non-limiting examples. In some aspects, the PEs 106(0)-106(P) may be reconfigurable, such that two or more of the PEs 106(0)-106(P) may be grouped into larger logical PEs having greater processing capabilities. It is to be understood that the vector-processor-based device 100 may include more or fewer vector processors than the vector processor 102 illustrated in FIG. 1, and/or may provide more or fewer PEs than the PEs 106(0)-106(P) illustrated in FIG. 1.

The PEs 106(0)-106(P) are each communicatively coupled to a crossbar 108, through which data (e.g., results of executing a loop iteration of a vectorizable loop) may be written to a vector register file 110. The vector register file 110 in the example of FIG. 1 is communicatively coupled, via a bidirectional communications path, to a direct memory access (DMA) controller 112, which is configured to perform memory access operations to read data from and write data to a system memory 114. The system memory 114 according to some aspects may comprise a double-data-rate (DDR) memory, as a non-limiting example. In exemplary operation, instruction blocks (not shown) are fetched from the system memory 114, and may be cached in an instruction block cache 116 to reduce the memory access latency associated with fetching frequently accessed instruction blocks. The instruction blocks are decoded by a decoder 118, and decoded instructions are assigned to a PE 106(0)-106(P) by the scheduler circuit 104 for execution. To facilitate execution, the PEs 106(0)-106(P) may receive live-in data values 120(0)-120(P) from the vector register file 110 as input, and, following execution of instructions, may write live-out data values 122(0)-122(P) as output to the vector register file 110 via the crossbar 108 using concurrent synchronized accesses.

It is to be understood that the vector-processor-based device 100 of FIG. 1 may include more or fewer elements than illustrated in FIG. 1. The vector-processor-based device 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

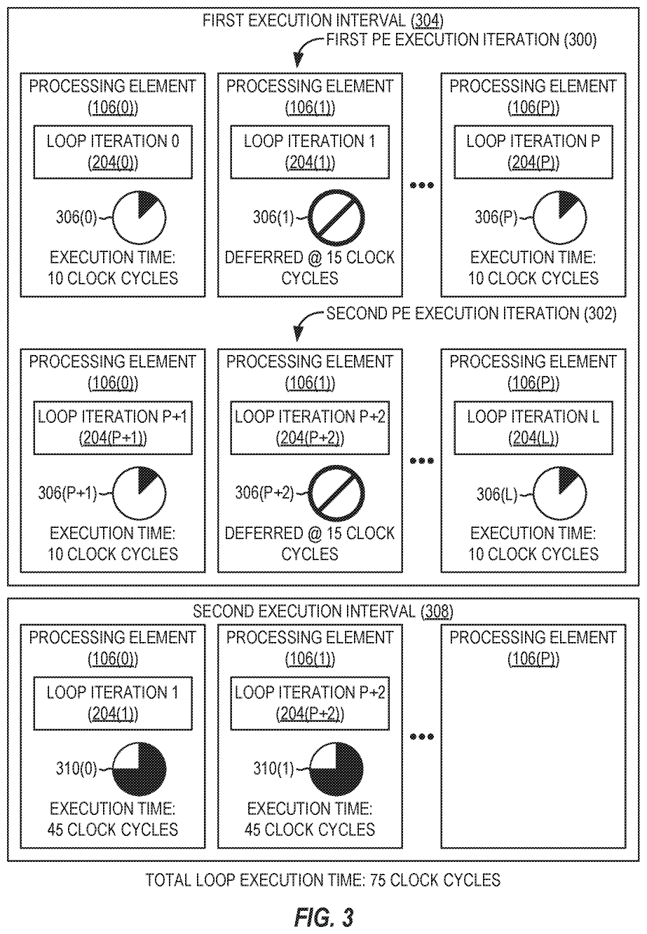

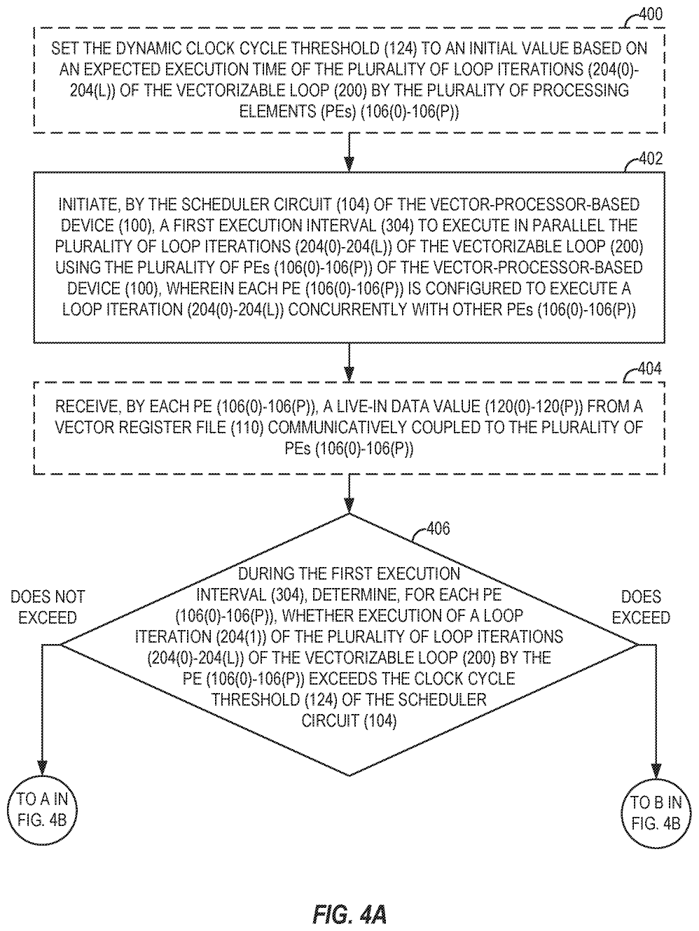

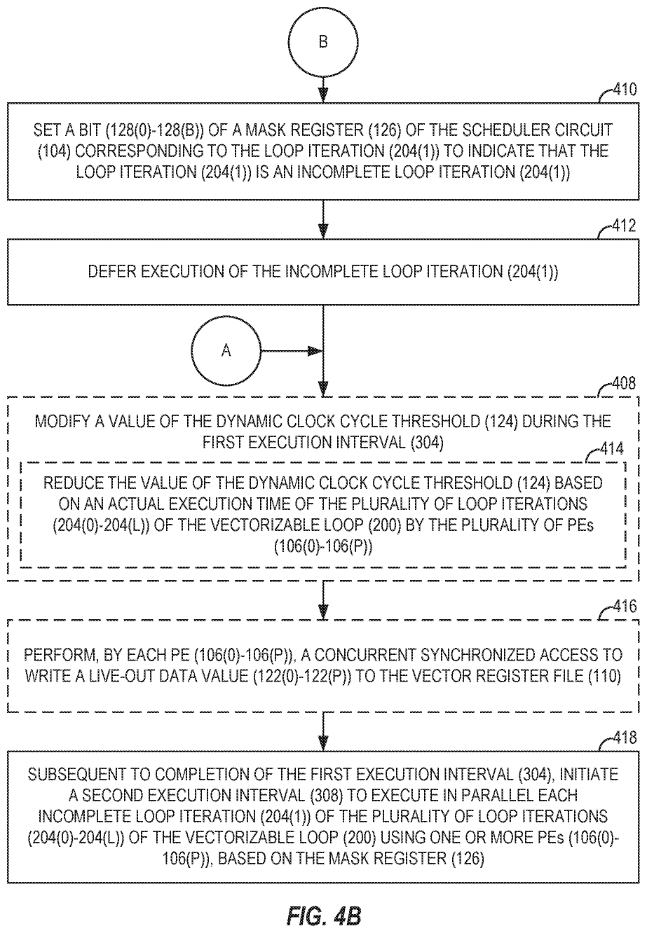

One application for which the vector-processor-based device 100 may be well-suited is processing vectorizable loops, which involves mapping each iteration of a vectorizable loop to a different PE of the plurality of PEs 106(0)-106(P), and then executing multiple loop iterations in parallel. However, as noted above, occurrences of branch divergence within the vectorizable loop may cause delays in processing, which may degrade overall processor performance and increase power consumption. To enable more efficient processing of vectorizable loops, the scheduler circuit 104 of FIG. 1 provides a clock cycle threshold 124 and a mask register 126 comprising a plurality of bits 128(0)-128(B). The operation of these elements of the scheduler circuit 104 are discussed in greater detail below with respect to FIGS. 3 and 4.

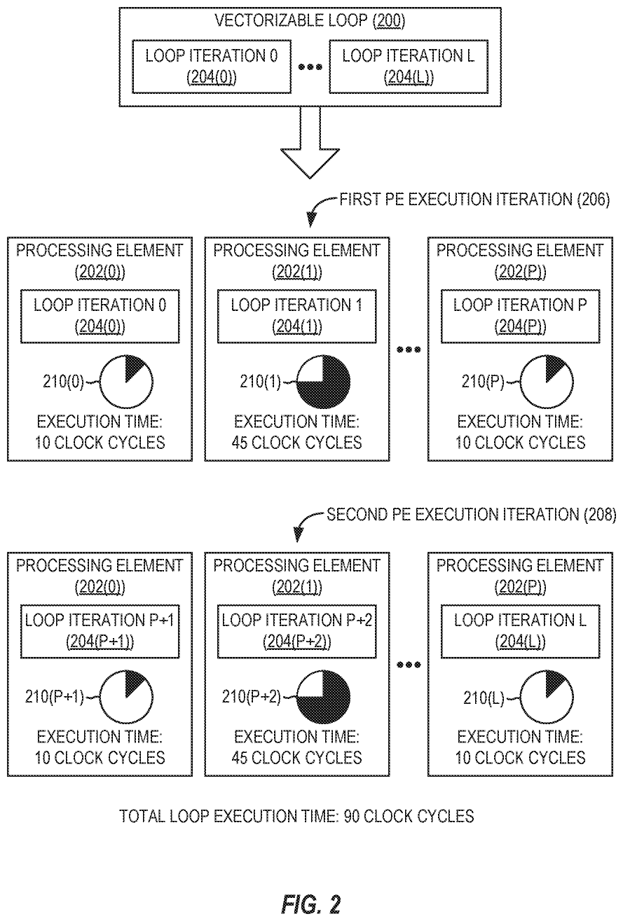

To illustrate the negative effects of branch divergence on the performance of a conventional vector processor, FIG. 2 is provided. In FIG. 2, a vectorizable loop 200 is to be processed by a conventional vector-processor-based device (not shown) comprising a plurality of PEs 202(0)-202(P). The vectorizable loop 200 is made up of a plurality of loop iterations 204(0)-204(L) (also referred to as “loop iteration 0,” “loop iteration L,” and so forth). It is assumed for the purposes of this example that each of the loop iterations 204(0)-204(L) can be independently executed by a PE 202(0)-202(P). Thus, for instance, there is no loop-carried dependence among the loop iterations 204(0)-204(L), or any other characteristics which would inhibit parallel processing of the loop iterations 204(0)-204(L).

It is further assumed that the number L of the loop iterations 204(0)-204(L) is twice the number P of the PEs 202(0)-202(P). As a result, half of the loop iterations 204(0)-204(L) (i.e., the loop iterations 204(0)-204(P)) are executed in parallel by the PEs 202(0)-202(P) in a first PE execution iteration 206, while the remaining loop iterations 204(0)-204(L) (i.e., the loop iterations 204(P+1)-204(L)) are executed in parallel by the PEs 202(0)-202(P) in a second PE execution iteration 208. The total processing time (measured in clock cycles) required to complete each of the first PE execution iteration 206 and the second PE execution iteration 208 will equal the longest execution time of each of the PEs 202(0)-202(P) within the first PE execution iteration 206 and the second PE execution iteration 208.

Thus, in the example of FIG. 2, the execution of each of the loop iterations 204(0) and 204(P) within the first PE execution iteration 206 consumes 10 clock cycles, as indicated by elements 210(0) and 210(P). However, due to an occurrence of branch divergence within the loop iteration 204(1), the PE 202(1) consumes 45 clock cycles to execute the loop iteration 204(1), as indicated by element 210(1). The total loop execution time for the first PE execution iteration 206 is therefore 45 clock cycles. Similarly, during the second PE execution iteration 208, the loop iterations 204(P+1) and 204(L) each require 10 clock cycles for execution by the PEs 202(0) and 202(P), as indicated by elements 210(P+1) and 210(L). An instance of branch divergence within the loop iteration 204(P+2) causes the PE 202(1) to consume 45 clock cycles to execute the loop iteration 204(P+2), as indicated by element 210(P+2). Consequently, the second PE execution iteration 208 also requires 45 clock cycles to complete, resulting in a total loop execution time of 90 clock cycles for the vectorizable loop 200.

In this regard, the scheduler circuit 104 of FIG. 1 is configured to provide efficient handling of branch divergence when processing vectorizable loops such as the vectorizable loop 200 of FIG. 2. Referring back to FIG. 1, the scheduler circuit 104 provides the clock cycle threshold 124 that represents a maximum number of clock cycles that may be consumed by each PE 106(0)-106(P) when processing a loop iteration of a vectorizable loop. During execution of loop iterations of the vectorizable loop by the PEs 106(0)-106(P), the scheduler circuit 104 may detect “late” PEs, or PEs that fail to complete execution of a corresponding loop iteration within the maximum number of clock cycles specified by the clock cycle threshold 124. As a non-limiting example, the scheduler circuit 104 may be configured to detect a late PE by observing the absence of a vector register file write operation (as well as other expected write operations associated with the corresponding loop iteration) from the late PE to the vector register file 110 before a number of clock cycles indicated by the clock cycle threshold 124 have elapsed. For instance, the scheduler circuit 104 may sample write-performed status signals (not shown) from the vector register file 110 to the scheduler circuit 104 after passage of the number of clock cycles indicated by the clock cycle threshold 124 after the start of each execution iteration by each of the PEs 106(0)-106(M).

In some aspects, the clock cycle threshold 124 may comprise a static clock cycle threshold 124 whose value remains unchanged during processing of a vectorizable loop. Some aspects may provide that the clock cycle threshold 124 may comprise a dynamic clock cycle threshold 124 having a value that may be modified by the scheduler circuit 104 during processing of a vectorizable loop. As a non-limiting example, in aspects in which the clock cycle threshold 124 is a dynamic clock cycle threshold 124, the scheduler circuit 104 may set the dynamic clock cycle threshold 124 to an initial value based on an expected execution time of each loop iteration of a vectorizable loop. As the vectorizable loop is executed, the scheduler circuit 104 may reduce the value of the dynamic clock cycle threshold 124 based on an actual execution time of the loop iterations of the vectorizable loop by the PEs 106(0)-106(P). According to some aspects, the clock cycle threshold 124 may be software-programmable by software being executed by the vector-processor-based device 100. For instance, the clock cycle threshold 124 may be set by software on a per-loop basis when executing vectorizable loops.

The scheduler circuit 104 also provides the mask register 126 comprising a plurality of bits 128(0)-128(B). The bits 128(0)-128(B) of the mask register 126 correspond to each loop iteration of a vectorizable loop being executed by the PEs 106(0)-106(P). During execution of a vectorizable loop, if a PE 106(0)-106(P) does not complete execution of each loop iteration within the number of clock cycles specified by the clock cycle threshold 124 (e.g., due to branch divergence within the loop iteration), the scheduler circuit 104 will set a bit 128(0)-128(B) corresponding to the loop iteration to indicate that the loop iteration is incomplete, and then will defer execution of the incomplete loop iteration. After all other loop iterations have completed execution, the scheduler circuit 104 re-executes any incomplete loop iterations as a group, thus minimizing the effect of branch divergence on the overall execution time of the vectorizable loop.

FIG. 3 illustrates in greater detail how the scheduler circuit 104 of FIG. 1 enables the vectorizable loop 200 of FIG. 2 to be more efficiently processed by the PEs 106(0)-106(P). As with FIG. 2, it is assumed that the number L of the loop iterations 204(0)-204(L) is twice the number P of the PEs 106(0)-106(P), such that half of the loop iterations 204(0)-204(L) (i.e., the loop iterations 204(0)-204(P)) are executed in parallel by the PEs 106(0)-106(P) in a first PE execution iteration 300, while the remaining loop iterations 204(0)-204(L) (i.e., the loop iterations 204(P+1)-204(L)) are executed in parallel by the PEs 106(0)-106(P) in a second PE execution iteration 302. It is also assumed that the clock cycle threshold 124 of the scheduler circuit 104 of FIG. 1 has a value of 15, indicating that any of the loop iterations 204(0)-204(L) that exceed 15 clock cycles during execution will be deferred.

As seen in FIG. 3, the scheduler circuit 104 first initiates a first execution interval 304, during which the first PE execution iteration 300 and the second PE execution iteration 302 are performed. During the first PE execution iteration 300, parallel execution of the loop iterations 204(0) and 204(P) by the PEs 106(0) and 106(P), respectively, consumes 10 clock cycles each, as indicated by elements 306(0) and 306(P). Execution of the loop iteration 204(1) by the PE 106(1), though, exceeds the 15-clock-cycle limit set by the clock cycle threshold 124 due to an occurrence of branch divergence within the loop iteration 204(1). Accordingly, the scheduler circuit 104 sets a bit 128(0)-128(B) of the mask register 126 corresponding to the loop iteration 204(1) to indicate that the loop iteration 204(1) is an incomplete loop iteration 204(1), and further execution of the incomplete loop iteration 204(1) is deferred to a second execution interval 308, as indicated by element 306(1). A similar sequence of events occurs during the second PE execution iteration 302, where the loop iterations 204(P+1) and 204(L) are completed in 10 clock cycles each, as indicated by elements 306(P+1) and 306(L), while a branch divergence within the loop iteration 204(P+2) causes execution of the loop iteration 204(P+2) to exceed the clock cycle threshold 124. The scheduler circuit 104 thus sets a bit 128(0)-128(B) of the mask register 126 corresponding to the loop iteration 204(P+2) to indicate that the loop iteration 204(P+2) is an incomplete loop iteration 204(P+2), and defers further execution of the loop iteration 204(P+2) until the second execution interval 308, as indicated by element 306(P+2). As a result, the total loop execution time for each of the first PE execution iteration 300 and the second PE execution iteration 302 is 15 clock cycles (i.e., the number of clock cycles that the loop iterations 204(1) and 204(P+2) were allowed to execute before being deferred).

After the first execution interval 304 concludes, all of the loop iterations 204(0)-204(L) have been executed with the exception of the loop iterations 204(1) and 204(P+2). Accordingly, the scheduler circuit 104 initiates the second execution interval 308. Based on the mask register 126, the scheduler circuit 104 identifies the loop iterations 204(1) and 204(P+2) as incomplete, and assigns the loop iterations 204(1) and 204(P+2) for parallel execution by the PEs 106(0) and 106(1), respectively. Execution of each of the loop iterations 204(1) and 204(P+2) consumes 45 clock cycles as indicated by elements 310(0) and 310(1), resulting in a total loop execution time of 45 clock cycles for the second execution interval 308. The execution time for the entire vectorizable loop 200 is therefore 75 clock cycles, which compares favorably to the 90-clock-cycle execution time of the vectorizable loop 200 illustrated in FIG. 2.

To illustrate exemplary operations for providing efficient handling of branch divergence in vectorizable loops such as the vectorizable loop 200 of FIG. 2, FIGS. 4A and 4B are provided. For the sake of clarity, elements of FIGS. 1-3 are referenced in describing FIGS. 4A and 4B. In aspects in which a dynamic clock cycle threshold 124 is employed, operations may begin with the scheduler circuit 104 setting the dynamic clock cycle threshold 124 to an initial value based on an expected execution time of the plurality of loop iterations 204(0)-204(L) of the vectorizable loop 200 by the plurality of PEs 106(0)-106(P) (block 400). The scheduler circuit 104 then initiates the first execution interval 304 of the plurality of loop iterations 204(0)-204(L) of the vectorizable loop 200 using the plurality of PEs 106(0)-106(P) of the vector-processor-based device 100, wherein each PE 106(0)-106(P) is configured to execute a loop iteration 204(0)-204(L) concurrently with other PEs 106(0)-106(P) (block 402). In this regard, the scheduler circuit 104 may be referred to herein as “a means for initiating a first execution interval to execute in parallel a plurality of loop iterations of a vectorizable loop using a plurality of PEs of the vector-processor-based device, wherein each PE is configured to execute a loop iteration of the plurality of loop iterations concurrently with other PEs of the plurality of PEs.” In some aspects, each PE 106(0)-106(P) may receive a live-in data value 120(0)-120(P) from the vector register file 110 communicatively coupled to the plurality of PEs 106(0)-106(P) (block 404).

During the first execution interval 304, the scheduler circuit 104 determines, for each PE 106(0)-106(P), whether execution of each loop iteration 204(0)-204(L) of the vectorizable loop 200 (such as the loop iteration 204(1)) by the PE 106(0)-106(P) exceeds the clock cycle threshold 124 of the scheduler circuit 104 (block 406). Accordingly, the scheduler circuit 104 may be referred to herein as “a means for determining, for each PE of the plurality of PEs during the first execution interval, whether execution of each loop iteration of the plurality of loop iterations of the vectorizable loop by the PE exceeds a clock cycle threshold.” If execution of the loop iteration 204(1) does not exceed the clock cycle threshold 124, processing resumes at block 408 of FIG. 4B. However, if it is determined at decision block 406 that execution of the loop iteration 204(1) does exceed the clock cycle threshold 124, processing resumes at block 410 of FIG. 4B.

Referring now to FIG. 4B, if the scheduler circuit 104 determines at decision block 406 that execution of the loop iteration 204(1) exceeds the clock cycle threshold 124, the scheduler circuit 104 sets a bit 128(0)-128(B) of the mask register 126 of the scheduler circuit 104 corresponding to the loop iteration 204(1) to indicate that the loop iteration 204(1) is an incomplete loop iteration 204(1) (block 410). The scheduler circuit 104 thus may be referred to herein as “a means for setting a bit of a mask register corresponding to the loop iteration to indicate that the loop iteration is an incomplete loop iteration, responsive to determining that the execution of the loop iteration exceeds the clock cycle threshold.” The scheduler circuit 104 then defers the execution of the incomplete loop iteration 204(1) (block 412). In this regard, the scheduler circuit 104 may be referred to herein as “a means for deferring execution of the incomplete loop iteration, further responsive to determining that the execution of the loop iteration exceeds the clock cycle threshold.”

In aspects in which the clock cycle threshold 124 is a dynamic clock cycle threshold 124, the scheduler circuit 104 may modify a value of the dynamic clock cycle threshold 124 during the first execution interval 304 (block 408). According to some aspects, operations of block 408 for modifying the value of the dynamic clock cycle threshold 124 may include reducing the value of the dynamic clock cycle threshold 124 based on an actual execution time of the plurality of loop iterations 204(0)-204(L) of the vectorizable loop 200 by the plurality of PEs 106(0)-106(P) (block 414). Some aspects may also provide that each PE 106(0)-106(P) may perform a concurrent synchronized access to write a live-out data value 122(0)-122(P) to the vector register file 110 (block 416). Finally, subsequent to completion of the first execution interval 304, the scheduler circuit 104 initiates a second execution interval 308 of each incomplete loop iteration 204(1) of the plurality of loop iterations 204(0)-204(L) of the vectorizable loop 200 using one or more PEs 106(0)-106(P), based on the mask register 126 (block 418). Accordingly, the scheduler circuit 104 may be referred to herein as “a means for initiating a second execution interval to execute in parallel each incomplete loop iteration of the plurality of loop iterations of the vectorizable loop using one or more PEs of the plurality of PEs subsequent to completion of the first execution interval, based on the mask register.”

Providing efficient handling of branch divergence in vectorizable loops by vector-processor-based devices according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

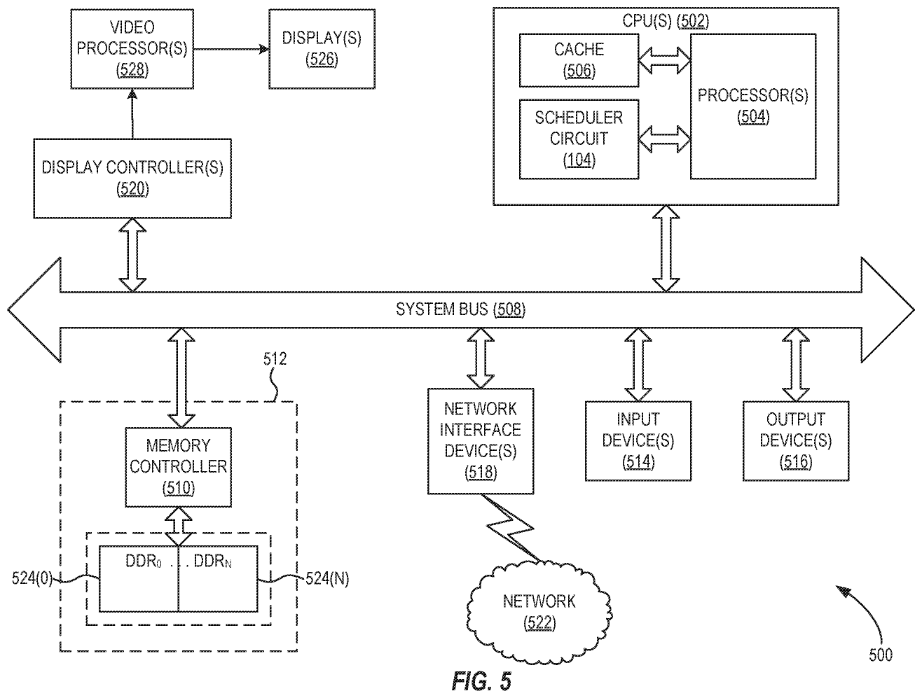

In this regard, FIG. 5 illustrates an example of a processor-based system 500 that can include the PEs 106(0)-106(P) of FIG. 1. The processor-based system 500 includes one or more central processing units (CPUs) 502, each including one or more processors 504 (which in some aspects may correspond to the PEs 106(0)-106(P) of FIG. 1). The CPU(s) 502 may have cache memory 506 coupled to the processor(s) 504 for rapid access to temporarily stored data, and, in some aspects, may include the scheduler circuit 104 of FIG. 1. The CPU(s) 502 is coupled to a system bus 508 and can intercouple master and slave devices included in the processor-based system 500. As is well known, the CPU(s) 502 communicates with these other devices by exchanging address, control, and data information over the system bus 508. For example, the CPU(s) 502 can communicate bus transaction requests to a memory controller 510 as an example of a slave device.

Other master and slave devices can be connected to the system bus 508. As illustrated in FIG. 5, these devices can include a memory system 512, one or more input devices 514, one or more output devices 516, one or more network interface devices 518, and one or more display controllers 520, as examples. The input device(s) 514 can include any type of input device, including but not limited to input keys, switches, voice processors, etc. The output device(s) 516 can include any type of output device, including, but not limited to, audio, video, other visual indicators, etc. The network interface device(s) 518 can be any devices configured to allow exchange of data to and from a network 522. The network 522 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 518 can be configured to support any type of communications protocol desired. The memory system 512 can include one or more memory units 524(0)-524(N).

The CPU(s) 502 may also be configured to access the display controller(s) 520 over the system bus 508 to control information sent to one or more displays 526. The display controller(s) 520 sends information to the display(s) 526 to be displayed via one or more video processors 528, which process the information to be displayed into a format suitable for the display(s) 526. The display(s) 526 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A vector-processor-based device for handling branch divergence in vectorizable loops, comprising:
a plurality of processing elements (PEs), each configured to execute a loop iteration of a plurality of loop iterations of a vectorizable loop concurrently with other PEs of the plurality of PEs; and
a scheduler circuit comprising a mask register and a clock cycle threshold, the scheduler circuit configured to:
initiate a first execution interval to execute in parallel the plurality of loop iterations of the vectorizable loop using the plurality of PEs;
during the first execution interval, determine, for each PE of the plurality of PEs, whether execution of each loop iteration of the plurality of loop iterations of the vectorizable loop by the PE exceeds the clock cycle threshold;
responsive to determining that the execution of the loop iteration exceeds the clock cycle threshold:
set a bit of the mask register corresponding to the loop iteration to indicate that the loop iteration is an incomplete loop iteration; and
defer execution of the incomplete loop iteration; and
subsequent to completion of the first execution interval, initiate a second execution interval to execute in parallel each incomplete loop iteration of the plurality of loop iterations of the vectorizable loop using one or more PEs of the plurality of PEs, based on the mask register.

2. The vector-processor-based device of claim 1, wherein the clock cycle threshold comprises a static clock cycle threshold having a value that remains unchanged during the first execution interval.

3. The vector-processor-based device of claim 1, wherein:
the clock cycle threshold comprises a dynamic clock cycle threshold; and
the scheduler circuit is further configured to modify a value of the dynamic clock cycle threshold during the first execution interval.

4. The vector-processor-based device of claim 3, wherein:
the scheduler circuit is further configured to set the dynamic clock cycle threshold to an initial value based on an expected execution time of the plurality of loop iterations of the vectorizable loop by the plurality of PEs; and
the scheduler circuit is configured to modify the value of the dynamic clock cycle threshold during the first execution interval by being configured to reduce the value of the dynamic clock cycle threshold based on an actual execution time of the plurality of loop iterations of the vectorizable loop by the plurality of PEs.

5. The vector-processor-based device of claim 1, wherein the clock cycle threshold is software-programmable.

6. The vector-processor-based device of claim 1, further comprising a vector register file communicatively coupled to the plurality of PEs;
wherein each PE of the plurality of PEs is further configured to:
prior to executing a loop iteration of the plurality of loop iterations of the vectorizable loop, receive a live-in data value from the vector register file; and
subsequent to executing the loop iteration of the plurality of loop iterations of the vectorizable loop, perform a concurrent synchronized access to write a live-out data value to the vector register file.

7. The vector-processor-based device of claim 1 integrated into an integrated circuit (IC).

8. The vector-processor-based device of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

9. A vector-processor-based device for handling branch divergence in vectorizable loops, comprising:
a means for initiating a first execution interval to execute in parallel a plurality of loop iterations of a vectorizable loop using a plurality of processing elements (PEs) of the vector-processor-based device, wherein each PE is configured to execute a loop iteration of the plurality of loop iterations concurrently with other PEs of the plurality of PEs;
a means for determining, for each PE of the plurality of PEs during the first execution interval, whether execution of each loop iteration of the plurality of loop iterations of the vectorizable loop by the PE exceeds a clock cycle threshold;
a means for setting a bit of a mask register corresponding to the loop iteration to indicate that the loop iteration is an incomplete loop iteration, responsive to determining that the execution of the loop iteration exceeds the clock cycle threshold;
a means for deferring execution of the incomplete loop iteration, further responsive to determining that the execution of the loop iteration exceeds the clock cycle threshold; and
a means for initiating a second execution interval to execute in parallel each incomplete loop iteration of the plurality of loop iterations of the vectorizable loop using one or more PEs of the plurality of PEs subsequent to completion of the first execution interval, based on the mask register.

10. A method for handling branch divergence in vectorizable loops, comprising:
initiating, by a scheduler circuit of a vector-processor-based device, a first execution interval to execute in parallel a plurality of loop iterations of a vectorizable loop using a plurality of processing elements (PEs) of the vector-processor-based device, wherein each PE is configured to execute a loop iteration of the plurality of loop iterations concurrently with other PEs of the plurality of PEs;
during the first execution interval, determining, for each PE of the plurality of PEs, whether execution of each loop iteration of the plurality of loop iterations of the vectorizable loop by the PE exceeds a clock cycle threshold of the scheduler circuit;
responsive to determining that the execution of the loop iteration exceeds the clock cycle threshold:
setting a bit of a mask register of the scheduler circuit corresponding to the loop iteration to indicate that the loop iteration is an incomplete loop iteration; and
deferring execution of the incomplete loop iteration; and
subsequent to completion of the first execution interval, initiating a second execution interval to execute in parallel each incomplete loop iteration of the plurality of loop iterations of the vectorizable loop using one or more PEs of the plurality of PEs, based on the mask register.

11. The method of claim 10, wherein the clock cycle threshold comprises a static clock cycle threshold having a value that remains unchanged during the first execution interval.

12. The method of claim 10, wherein:
the clock cycle threshold comprises a dynamic clock cycle threshold; and
the method further comprises modifying a value of the dynamic clock cycle threshold during the first execution interval.

13. The method of claim 12, wherein:
the method further comprises setting the dynamic clock cycle threshold to an initial value based on an expected execution time of the plurality of loop iterations of the vectorizable loop by the plurality of PEs; and
the method comprises modifying the value of the dynamic clock cycle threshold during the first execution interval by reducing the value of the dynamic clock cycle threshold based on an actual execution time of the plurality of loop iterations of the vectorizable loop by the plurality of PEs.

14. The method of claim 10, wherein the clock cycle threshold is software-programmable.

15. The method of claim 10, further comprising:
prior to executing a loop iteration of the plurality of loop iterations of the vectorizable loop, receiving, by each PE of the plurality of PEs, a live-in data value from a vector register file communicatively coupled to the plurality of PEs; and
subsequent to executing the loop iteration of the plurality of loop iterations of the vectorizable loop, performing, by each PE of the plurality of PEs, a concurrent synchronized access to write a live-out data value to the vector register file.

16. A non-transitory computer-readable medium, having stored thereon computer-executable instructions for causing a vector processor of a vector-processor-based device to:
initiate a first execution interval to execute in parallel a plurality of loop iterations of a vectorizable loop using a plurality of processing elements (PEs) of the vector-processor-based device, wherein each PE is configured to execute a loop iteration of the plurality of loop iterations concurrently with other PEs of the plurality of PEs;
during the first execution interval, determine, for each PE of the plurality of PEs, whether execution of each loop iteration of the plurality of loop iterations of the vectorizable loop by the PE exceeds a clock cycle threshold;
responsive to determining that the execution of the loop iteration exceeds the clock cycle threshold:
set a bit of a mask register corresponding to the loop iteration to indicate that the loop iteration is an incomplete loop iteration; and
defer execution of the incomplete loop iteration; and
subsequent to completion of the first execution interval, initiate a second execution interval to execute in parallel each incomplete loop iteration of the plurality of loop iterations of the vectorizable loop using one or more PEs of the plurality of PEs, based on the mask register.

17. The non-transitory computer-readable medium of claim 16, wherein the clock cycle threshold comprises a static clock cycle threshold having a value that remains unchanged during the first execution interval.

18. The non-transitory computer-readable medium of claim 16, wherein:
the clock cycle threshold comprises a dynamic clock cycle threshold; and
the non-transitory computer-readable medium stores thereon computer-executable instructions for further causing the vector processor to modify a value of the dynamic clock cycle threshold during the first execution interval.

19. The non-transitory computer-readable medium of claim 18, wherein:
the non-transitory computer-readable medium stores thereon computer-executable instructions for further causing the vector processor to set the dynamic clock cycle threshold to an initial value based on an expected execution time of the plurality of loop iterations of the vectorizable loop by the plurality of PEs; and
the non-transitory computer-readable medium stores thereon computer-executable instructions for causing the vector processor to modify the value of the dynamic clock cycle threshold during the first execution interval by causing the vector processor to reduce the value of the dynamic clock cycle threshold based on an actual execution time of the plurality of loop iterations of the vectorizable loop by the plurality of PEs.

20. The non-transitory computer-readable medium of claim 16, wherein the clock cycle threshold is software-programmable.

21. The non-transitory computer-readable medium of claim 16 having stored thereon computer-executable instructions for further causing the vector processor to:
prior to executing a loop iteration of the plurality of loop iterations of the vectorizable loop, receive, by each PE of the plurality of PEs, a live-in data value from a vector register file communicatively coupled to the plurality of PEs; and
subsequent to executing the loop iteration of the plurality of loop iterations of the vectorizable loop, perform, by each PE of the plurality of PEs, a concurrent synchronized access to write a live-out data value to the vector register file.
